(19) United States
(12) Patent Application Publication
(10) Pub. No.: US 2011/0035434 A1
(43) Pub. Date: Feb. 10, 2011

(54) PROCESSING OF MESSAGING SERVICE ATTRIBUTES IN COMMUNICATION SYSTEMS

(75) Inventor: Robert James Lockwood, Richmond, VA (US)

Correspondence Address: JACOBSON HOLMAN PLLC, 400 SEVENTH STREET N.W., SUITE 600, WASHINGTON, DC, 20004, US

(73) Assignee: MARKPORT LIMITED, Dublin (IE)

(21) Appl. No.: 12/736,244

(22) PCT Filed: Mar. 26, 2009
(86) PCT No.: PCT/IE2009/000009

§ 371 Date: Oct. 20, 2010

Related U.S. Application Data
(60) Provisional application No. 61/064,805, filed on Mar. 27, 2008.

(51) Int. Cl. G06F 15/16

(52) U.S. Cl. 709/203; 709/201

(57) ABSTRACT

A messaging system (1) has a provisioning server (2), an application server (3), a notification server (4), a mail server (7), and a voice/video server (8) which act as clients toward an LDAP directory server (5). A proxy (“DAP”, 6) performs high speed write operations on a subset of attributes which it determines to be dynamic attributes. LDAP client requests that do not involve dynamic attributes are forwarded to the directory server (5) in a conventional manner. The proxy (6) also joins the results of requests that have both high-speed dynamic attributes as well as “static” attributes that are stored in a directory server (5). “Intelligent” services that involve maintaining dynamic attributes for large number of subscribers in a distributed environment can be deployed.

### FIELD OF THE INVENTION

The invention relates to messaging systems, and more particularly to the manner of storage, retrieval, and update of messaging service attributes in real time.

### PRIOR ART DISCUSSION

The Lightweight Directory Access Protocol (LDAP) is commonly used to store subscriber-specific, or configuration-specific information in an open-standards based VOIP system such as voicemail or videomail. There are many scenarios where it is desirable to provide high speed reliable dynamic attributes on a per-subscriber basis. While LDAP backends provide high speed reading ability that is scalable to support systems supporting millions of subscribers, the throughput on writes to LDAP databases is not sufficient to support dynamic attributes that scale to millions of subscribers.

U.S. Pat. No. 7,035,846 (IBM) describes a framework for answering LDAP queries. A proxy server maintains a cache of information about queries and uses this information to determine if a current query can be answered from the local cache.

U.S. Pat. No. 6,779,025 (Cisco) describes an application server for providing subscriber attribute information from a remote database server.

Although the “write” performance of LDAP servers is improving with some implementations providing throughput of up to hundreds of writes per second, these throughputs fall short of the current requirements of thousands of writes per second.

The invention is directed towards achieving improved write performance for directories, thus enabling enhanced real time messaging services to be performed.

### SUMMARY OF THE INVENTION

According to the invention, there is provided a messaging system for a communication network, the system comprising at least one directory server, wherein the system further comprises a proxy having a database storing a subset of messaging service attributes and the balance of the attributes being stored in the directory server, and the proxy comprises a server adapted to:
intercept client requests directed to the directory server,
identify, according to a criterion, a subset of attributes associated with the request as dynamic attributes, and to perform high speed write operations on said dynamic attributes in the proxy database to provide enhanced messaging services,
direct requests for the other attributes to the directory server, and to provide a client response.

In one embodiment, the proxy is adapted to identify attributes as dynamic according to a configuration table.

In one embodiment, the proxy is adapted to identify as a dynamic attribute an attribute which is a count of a number of times a particular operation has been performed for a subscriber.

In one embodiment, the proxy is adapted to cease maintaining a count of a particular operation when the count value exceeds a threshold.

In one embodiment, the proxy is adapted to perform a write to the directory server of a dynamic attribute when it lies outside a configured range, so that said attribute ceases to be a dynamic attribute.

Preferably, the proxy is adapted to identify as a dynamic attribute an attribute which is a count of a number of times a particular item of content has been automatically downloaded to a subscriber.

In one embodiment, the proxy is adapted to identify as a dynamic attribute an attribute which is a count of a number of times a notification has been automatically transmitted to a subscriber.

In one embodiment, the proxy is also adapted to perform retrieve, modify, or delete operations on said dynamic attributes and to add a new dynamic attribute to the proxy database.

In one embodiment, the proxy is adapted to generate results using dynamic attributes which it has written to the proxy database and to generate results from requests to the directory server, and to join said results to provide the client response.

In another embodiment, the proxy database is organised as a hash table with a subscriber identifier as a hash key.

In one embodiment, in the proxy database, proxy keys are correlated with directory server keys using a protocol for routing of requests to be handled by the directory server. In one embodiment, said protocol is LDAP.

In one embodiment, a subscriber identifier such as a telephone number is a correlation key.

In one embodiment, the proxy is multi-threaded in a manner to handle many requests in parallel in a reliable manner.

In one embodiment, the proxy ensures that transactions are atomic for concurrent access to attributes for a subscriber.

In one embodiment, the proxy performs atomic transactions composed of reading a record; verifying that a current record value is the same as a current value of a request; changing the current value to that in the request; and writing the record.

In one embodiment, the proxy uses at least one mutex for operations to ensure atomicity.

In one embodiment, the proxy is adapted to delete attributes and/or records from its database and to write them to the directory server.

In one embodiment, the system further comprises at least one server acting as a client, and wherein the proxy is adapted to process requests from one or more servers to provide to the server real time access to the dynamic attributes in a manner which is transparent to the server acting as a client.

In one embodiment, the system further comprises a provisioning server acting as a client of the proxy, and wherein the proxy is adapted to:
receive from the provisioning server a request to create records for a new subscriber, partition the request into dynamic and static attributes, servicing the dynamic attributes itself and passing the remainder of the request to the directory server,
join results from provisioning of both the dynamic attributes and the static attributes to return a provisioning status response to the provisioning server.

In one embodiment, the system further comprises a notification server acting as a client, and wherein the proxy is adapted to:
receive from the notification server a query to retrieve notification preferences and settings for a subscriber for whom a message has been deposited in a mailbox;
process dynamic attributes of the query locally, and pass the remainder of the query to the directory server; and to
subsequently join results for the full query and pass them to the notification server.

In one embodiment:
the notification server is adapted to use the dynamic attributes within a directory server request to determine if a notification which is to be sent to a subscriber is one of a first number of notifications, and the proxy server is adapted to provide this information by using results from the proxy database, and the proxy server is adapted to subsequently perform a write to a dynamic attribute in response to the notification server requesting modification of this dynamic attribute in order to increment the notification count, and the notification server is adapted to alter a notification to the subscriber to include a message that reminds the subscriber how to login to their mailbox and send the resultant notification, and to provide an intelligent interface.

In one embodiment, the system further comprises a video/voice server and an application server, and wherein the system is adapted to perform the method steps of:
the video/voice server receiving a subscriber call and handing off the call to the application server;
the application server issuing a query to retrieve the settings and preferences for this subscriber;
the proxy processing dynamic attributes of the query locally and passing the remainder of the query to the directory server; and joining the results for all attributes of the query and passing them to the application server.

In one embodiment, the system is adapted to perform the additional steps of:
the application server determining that the class of service for this subscriber requires that verbose versions of the menus are to be played if the subscriber has logged in less than N times, and noting from result of a query to the proxy that the value of this dynamic attribute is less than N and issuing a modify request to the proxy to increment this value; the proxy processing the modification of the dynamic attribute, writing the modified value to its database, and returning the result;
the application server counting and classifying messages in the subscriber's mail box;
the application server instructing the voice/video server to play the subscriber's messages and enabling verbose prompting because the login count was less than N, the application server thereby providing an intelligent interface because of the services of the proxy; and the voice/video server retrieving messages from the store and playing them to the subscriber.

In one embodiment, the proxy is adapted to use dynamic attributes to control playing of content such as a broadcast alert or advertising content each time a subscriber logs on or receives a notification, and to perform cycling by playing a next item of content if there have been N repetitions of playing current content over a number of messaging sessions for a particular subscriber, a count up to N being a dynamic attribute, and an identifier of current content being another dynamic attribute; and the proxy updating the count dynamic attribute each time content has been played for the subscriber, and updating the current content identifier dynamic attribute upon commencement of each cycle.

In one embodiment, the subset of attributes identified as dynamic include attributes for handling any data that has transient values, such as Boolean dynamic attributes to indicate whether a subscriber needs a specific service.

In one embodiment, the subset of attributes includes attributes to record whether an A-party subscriber has already received an out-of-office notification from a given B-party subscriber, wherein a dynamic attribute holds for the out-of-office B-party subscriber the MSISDN of one more A-party to whom an OOTO notification is sent in response to a message delivery attempt from such an A-party to the B-party, and wherein another dynamic attribute indicates whether the B-party subscriber has out-of-office notification service activated.

In one embodiment, the proxy is adapted to map IP addresses to MSISDNs, whereby instead of storing the IP address to MSISDN mapping in a Radius store, a WAP gateway instead does an LDAP add operation to the proxy when a start accounting request is received.

In one embodiment, the proxy is adapted to delete a mapping when a stop accounting request is received.

In one embodiment, the proxy is adapted to combine contents of the Radius store in its database with the subscriber data in LDAP and return this data as a single query result.

In another aspect, the invention provides a computer program product comprising a computer usable medium having a computer readable program code embodied therein, said computer readable code adapted to be executed to implement the steps of:
intercept messaging-related client requests directed to a directory server,
identify, according to a criterion, a subset of attributes associated with the request as dynamic attributes, and perform high speed write operations on said dynamic attributes in a proxy database to provide enhanced messaging services,
direct requests for the other attributes to the directory server, and to provide a client response.

### DETAILED DESCRIPTION OF THE INVENTION

The invention will be more clearly understood from the following description of some embodiments thereof, given by way of example only with reference to the accompanying drawings in which:—

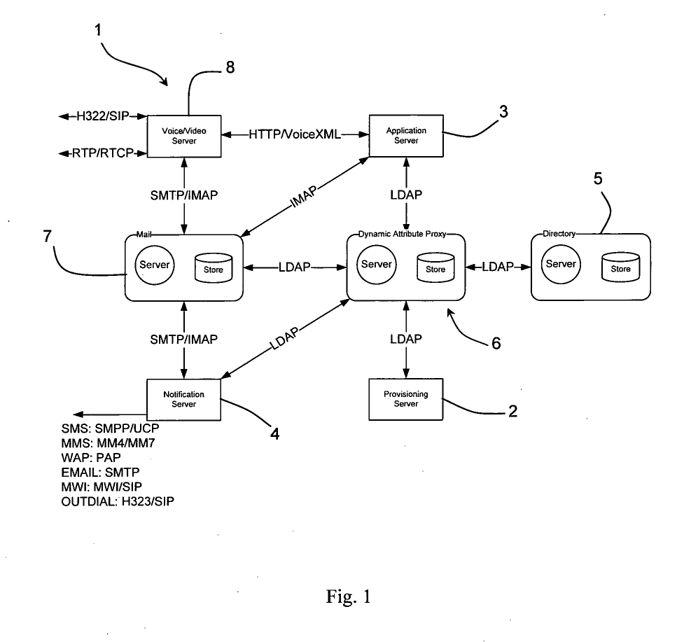

FIG. 1 is a diagram illustrating context of the invention;

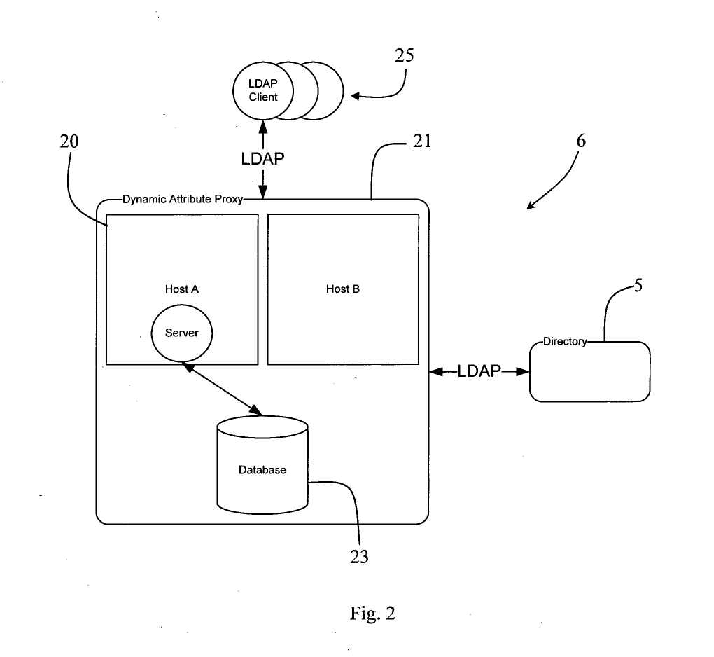

FIG. 2 is a diagram illustrating a dynamic attribute proxy of the invention;

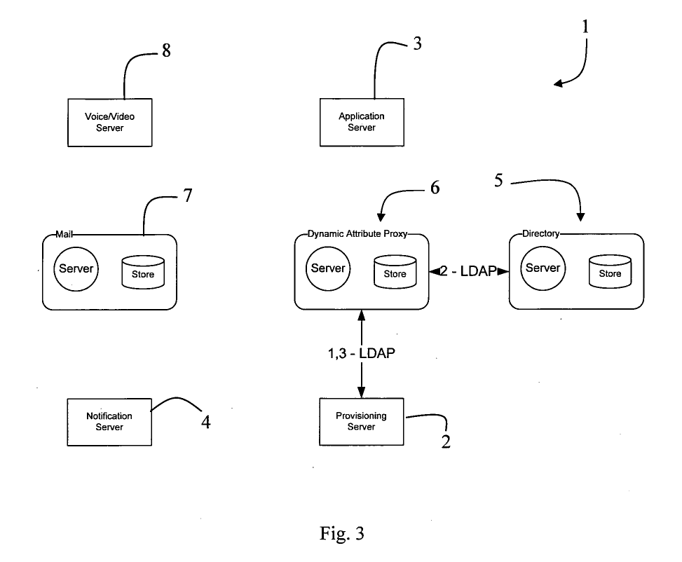

FIG. 3 is a diagram illustrating a provisioning method;

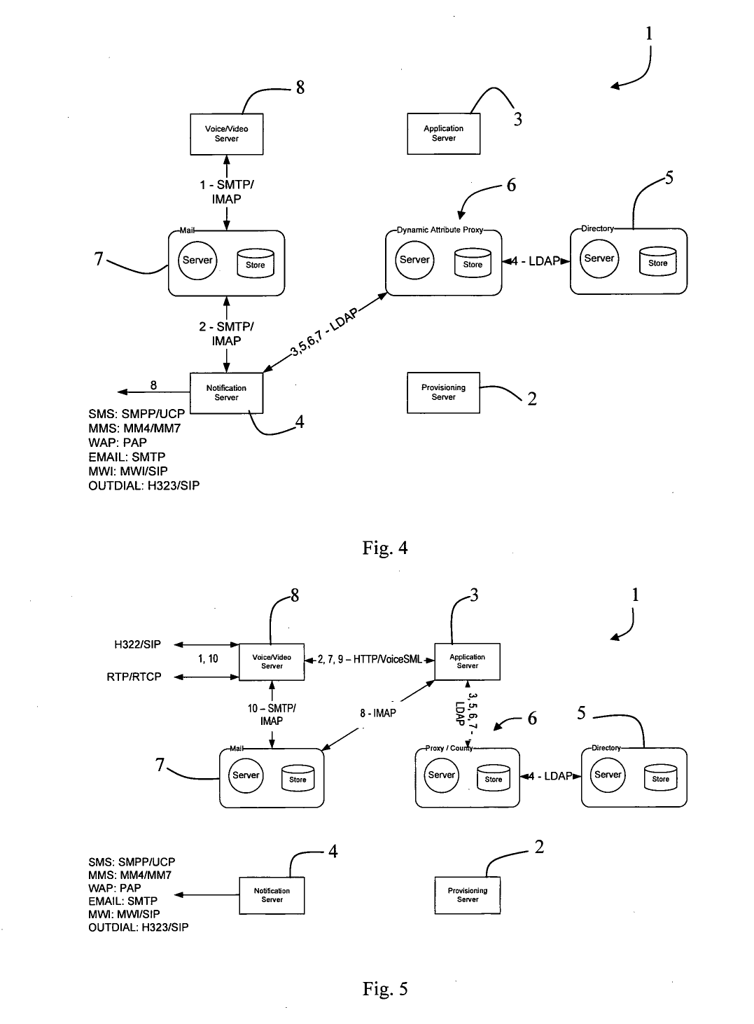

FIG. 4 is a diagram illustrating a notification method;

FIG. 5 is a diagram illustrating a subscriber login method;

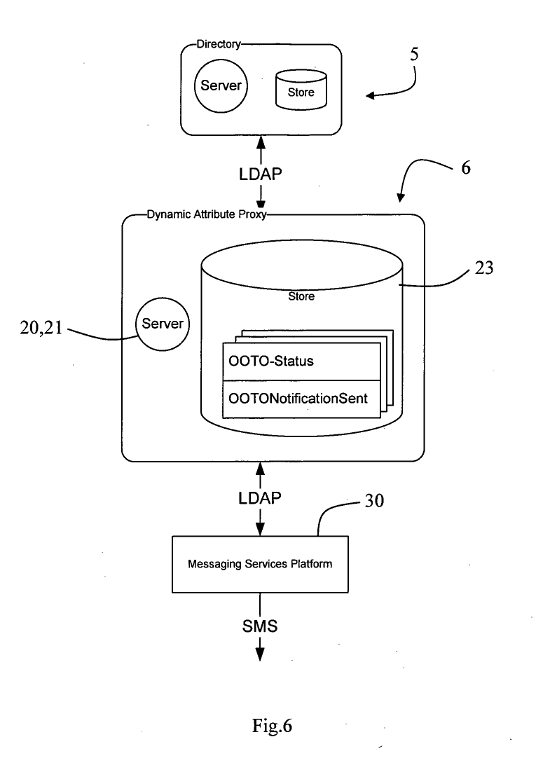

FIG. 6 is a diagram illustrating operation of the proxy for handling data having transient values; and

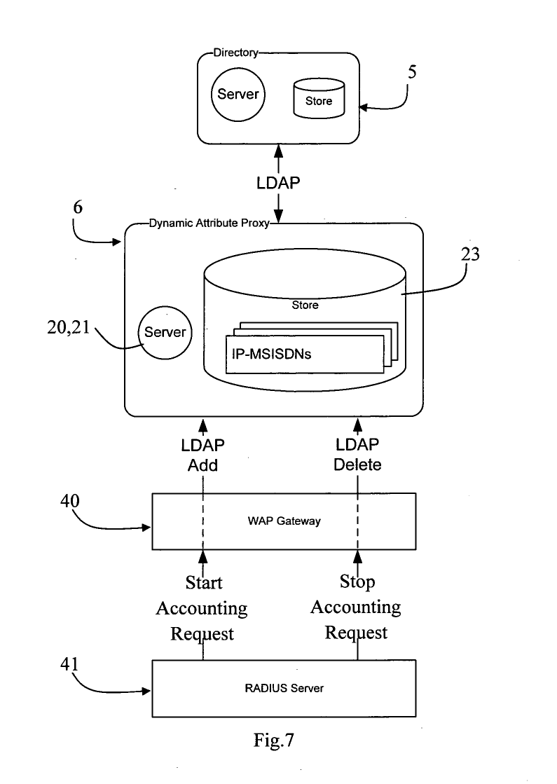

FIG. 7 is a diagram illustrating operation of the proxy for mapping IP addresses to MSISDNs.

### DESCRIPTION OF THE INVENTION

Glossary of terms and their definitions:

| | |
|---|---|
| HA | High Availability |
| LDAP | Lightweight Directory Access Protocol |
| DAP | Dynamic Attribute Proxy |

Referring to FIG. 1 a voice/video services architecture 1 is shown including a provisioning server 2, an application server 3, a notification server 4, a mail server 7, and a voice/video server 8 which act as clients towards an LDAP directory server 5. The invention provides a dynamic attribute proxy (“DAP”) 6 with the ability to perform high speed operations on dynamic attributes, in particular high speed write operations. It allows the servers to provide enhancements to their business logic and ultimately the voice/video mail subscriber's experience.

The DAP 6 intercepts operations for a small number of attributes for each subscriber and provides high-speed, reliable access to these attributes. The proxy 6 provides add, delete, modify and retrieve operations, but only provides those operations for the attributes that require high speed dynamics. LDAP client requests that do not address these attributes are forwarded to the directory server 5 in a conventional manner. The proxy 6 is also responsible for effectively joining the results of requests that have both high-speed dynamic attributes as well as “static” attributes that are stored in a directory server 5.

Because the proxy 6 intercepts and services such requests with high speed and reliability in a highly available environment, “intelligent” services that involve maintaining dynamic attributes for large numbers of subscribers in a distributed environment can be deployed.

FIG. 2 shows a more detailed view of the proxy 6. It comprises highly available servers in hosts 20 (“Host A”) and 21 (“Host B”) and a database 23 that provide both a proxy LDAP service and the ability to perform high-speed operations on dynamic attributes, in particular high speed write operations. This diagram also shows LDAP clients 25 making LDAP requests, and the LDAP interface of the proxy 6 to the directory server 5.

The database 23 may reside in either a RAID or a SAN and is physically connected to the two-host cluster 20, 21 via a high-speed bus (SCSI or FIBRE in two embodiments). The RAID or SAN provide the database 23 as highly available to the nodes which comprise the DAP 6.

Logically, the database 23 is organized as a hash table. The key to the hash table is correlated with a key used by the directory server. In one embodiment, the subscriber's telephone number is this key. Multiple keys could be used. The hash table provides extremely efficient access, particularly if the hash key is the subscriber's MSISDN, and most preferably if this correlates with the key used by the directory server.

The DAP 6 severs 20 and 21 are the only writer and only reader of the database 23. The DAP 6 may serve any number of clients at a time (multi-threaded application), but is responsible for ensuring that each of the transactions that it performs are atomic. For example, the DAP 6 performs the following actions on an LDAP_MODIFY of a given dynamic attribute:

1. Read the record
2. Verify current value same as current value in request
3. Change current value to new value in request
4. Write the record

The DAP 6 ensures that these actions are atomic by using a mutex around these operations such that only one thread of execution can manipulate the dynamic attribute for a given key at a time. A simple DAP can use a single mutex for all transactions, but a more sophisticated DAP can map each request (based on telephone number) to one of many mutexes to achieve even more parallelism. We have shown however, that a single mutex is sufficient to achieve thousands of writes per second.

The DAP 6 is installed as a service under a highly-available cluster (in this simple example, Host A 20 and Host B 21). The service is typically deployed as a pair of hosts (nodes) arranged such that the cluster server is in an active/passive configuration.

LDAP clients connect to the DAP 6 using the standard LDAP protocol. The DAP 6 proxies requests to the directory server 5 and locally intercepts and processes attributes that have been identified as dynamic. The dynamic attributes can be identified to the DAP 6 by a simple configuration table such as the example presented in Table 1 below.

TABLE 1

| | | Key | Dynamic | Multi- | |
|---|---|---|---|---|---|
| Attribute | Type | Value | Range | Valued | Description |
| NotificationCount | Integer | No | 0-10 | No | Counts the number of |
| | | | | | initial notifications so that |
| | | | | | initial notifications can |
| | | | | | provide “intelligent” help |
| AdvertiseItem | Integer | No | Unbounded | No | Identifies which item is |
| | | | | | being advertised |
| AdvertiseCount | Integer | No | Unbounded | No | Counts the number of |
| | | | | | times the current item has |
| | | | | | been advertised |
| LoginCount | Integer | No | 0-10 | No | Counts the number of |
| | | | | | initial logins so that initial |
| | | | | | logins can provide |
| | | | | | “intelligent” help. |
| OOTO-Status | Boolean | No | Yes/No | No | Indicates whether the |
| | | | | | subscriber has out-of- |
| | | | | | office notification (OOTO) |
| | | | | | turned on |
| OOTONotificationSent | String | No | Unbounded | Yes | This attribute holds for an |
| | | | | | out-of-office B-party |
| | | | | | Subscriber the MSISDN of |
| | | | | | each A-party to whom an |
| | | | | | OOTO notification is sent |
| | | | | | in response to a message |
| | | | | | delivery attempt from such |
| | | | | | an A-party to the B-party. |
| Telephonenumber | String | Yes | Unbounded | No | This attribute is used as |
| | | | | | the correlation key |
| | | | | | between the DAP and the |
| | | | | | directory server. |

There are three particularly important data flows:

### 1. Provisioning

### 2. Notification

### 3. Subscriber Login

An example of each of these flows is discussed below.

FIG. 3 shows a data flow corresponding to provisioning. The data flow for provisioning is as follows:
1) The provisioning server issues an LDAP Add to create records for a new subscriber
2) The DAP partitions the request into “dynamic” and “static” attributes, servicing the dynamic attributes itself and passing the remainder of the request to the directory server. Consider an LDAP Add of the following record (where “dn” means distinguish name, “dc” means domain component, and “cn” means common name):
   dn: telephonenumber=8045550000,dc=example,dc=com
   telephonenumber: 8045550000
   cn: John Doe
   notificationcount: 0

In this example, the DAP 6 partitions the record such that a new record is created on the directory server and additionally a new record is created on the DAP 6 with the NotificationCount=0 for key telephone number=8045550000.
3) To ensure consistency and enable roll-back the DAP 6 joins the results of both the dynamic attribute and the static attribute creation and returns the result to the provisioning server.

FIG. 4 shows a data flow corresponding to notification, as follows:
1. A voice or video message is deposited in the mailbox of a subscriber via SMTP. Note that the call setup steps for this scenario are not shown.
2. The notification server then receives a copy of the message via a SMTP copy-forward mechanism.
3. The notification server issues an LDAP query to retrieve the notification preferences and settings for the subscriber.
4. The DAP 6 processes the dynamic attributes locally and passes the remainder of the LDAP query to the directory server.
5. The DAP 6 joins the results and passes them to the notification server.
6. The notification server determines that the class of service for this subscriber requires that he be offered a tutorial if this is one of his first 10 notifications. Since the retrieved dynamic attribute corresponding to the notification count is less than 10, the notification server issues an LDAP modify to increment the notification count. For example, the following LDAP modify request would increment NotificationCount from 9 to 10 for the subscriber 8045550000
   dn: telephonenumber=8045550000,dc=example,dc=com
   changetype: modify
   replace: notificationcount
   notificationcount: 9
   notificationcount: 10
7. The DAP 6 processes the modification of the dynamic attribute and returns the result. With the configuration specified in Table 1 and the record specified in 6, the DAP 6 processes the LDAP modify entirely on its own, providing high speed write access to the NotificationCount attribute.
8. The notification server 4 alters its notification to include a message that reminds a subscriber how to login to their mailbox and sends the resultant notification. The notification server 4 is able to provide this “Intelligent” interface because of the services of the DAP 6.

In a similar manner, dynamic attributes could have been used to control the delivery of advertising content. For example, the “intelligent” service of playing an advertisement each time a subscriber logs on and cycling to the next advertisement after n repetitions, can easily be realized with two controlling dynamic attributes (one identifying which advertisement and one identifying repetition count).

FIG. 5 shows the data flow for a subscriber logging in to his mailbox.
1. The subscribers call arrives at the voice/video server 8. This may be either a voice or a video call depending on the type of service the subscriber has.
2. The call is handed off to the application server 3.
3. The application server 3 issues an LDAP query to retrieve the settings and preferences for this subscriber.
4. The DAP 6 processes the dynamic attributes locally and passes the remainder of the query to the directory server.
5. The DAP 6 joins the results and passes them to the application server 3.
6. The application server 3 determines that the class of service for this subscriber requires that verbose versions of the menus are to be played if the subscriber has logged in less than 10 times. The application server 3 notes that this value is less than 10 and issues an LDAP modify to increment this value.
7. The DAP processes the modification of the dynamic attribute and returns the result.
8. The application server 3 counts and classifies messages in the subscriber's mail box.
9. The application server 3 instructs the voice/video server 8 to play the subscriber's messages and enables verbose prompting because the login count was less than 10. The application server 3 is able to provide this “Intelligent” interface because of the services of the DAP. In a similar manner, dynamic attributes could have been used to control the delivery of advertising content.
10. The voice/video server 8 retrieves messages from the store and plays them to the subscriber.

As can be seen from the above data flow examples, the DAP 6 is used as a mid-stream probe/interceptor. The content of interest is configurable and initialized by the provisioning server, the DAP 6 probes the LDAP stream and acts on the subset of data of interest and provides fast write support for that subset. The above examples all involve taking an action a fixed number of times for each subscriber, and using dynamic attributes for the purpose of counting. The examples apply equally well to both the videomail and the voicemail domains. In the scenarios where the DAP 6 is used to count up or down to a certain value, the attribute loses its need to be a dynamic attribute once it reaches the specified limit. By specifying the range of values under which an attribute needs to be dynamic, the DAP 6 can automatically remove a dynamic attribute from control of the DAP 6 once it reaches a limit, by simply writing the value of the attribute (once) to the directory 5 store and removing the attribute from its own store. By performing this as a low priority background task, the DAP 6 can ensure that the last write achieves the same high performance as other writes and the DAP 6 can also keep its internal database minimally sized to achieve continued high performance. All of the writes performed to the DAP 6 database are dynamic and there is no advantage to synchronising the directory 5 store with it until after the value reaches a limit. Of course, all requests are made to the DAP 6 and so there is no risk of out of date information being provided.

Referring to FIG. 6, dynamic attributes may also be used for handling any data that has transient values. For example, Boolean dynamic attributes may be used to indicate whether a subscriber needs a specific service. One example of this is that an enhanced personalised messaging services platform 30 which offers advanced messaging services (using bearer SMS, i.e. in conjunction with the SMSC) could use dynamic attributes to remember whether a subscriber has already received an out-of-office notification on behalf of a given B-party subscriber. To support this using the DAP 6 the out-of-office B-party subscriber-record is defined with an attribute e.g. OOTO-Status (=on/off) and a separate multi-valued attribute OOTONotificationSent(=A-party MSISDN(s)) which holds the MSISDN of each A-party to whom an OOTO notification is sent in response to a message delivery attempt from such an A-party to the B-party. In an alternative embodiment, when a new A-party attempts message delivery to the out-of-office B-party another OOTONotificationSent attribute is added by the proxy 6 to the B-party subscriber record containing the A-party MSISDN. The enhanced personalised messaging services platform 30 can also interact with the DAP 6 to disable/reset the OOTO dynamic attributes and the list of originators can be cleared from the DAP.

Referring to FIG. 7, another use case involves a Radius store within a WAP gateway 40. The WAP gateway 40 normally maintains a Radius store 41 containing a mapping of IP addresses to MSISDNs. When a Radius start accounting request is received from the network, it stores a new IP address to MSISDN mapping in the Radius store, when a Radius stop accounting request is received it removes an IP address to MSISDN mapping from the Radius store. In addition, it uses an LDAP-based subscriber database and offers a query interface to other applications that can query the Radius store to obtain the IP address-to-MSISDN mapping. The reason for having a separate Radius store is the inadequate write speed of LDAP, as otherwise the IP address could also be stored as a queryable attribute in the LDAP based subscriber database.

The invention allows a much simpler implementation of this functionality. Instead of having a separate Radius store in the WAP gateway and a separate query interface, the DAP performs a highly efficient mechanism mapping IP addresses to MSISDNs (effectively the information in the Radius store). Instead of storing the IP address to MSISDN mapping in the Radius store, the WAP gateway instead does an LDAP add operation to the DAP when the start accounting request is received. As a result, the DAP will introduce this mapping in the DAP database. Any other system needing the IP address as part of the subscriber data will do a standard LDAP query to the DAP. The DAP will combine the contents of the Radius store in the DAP with the subscriber data in LDAP and return this data as a single query result, allowing a much simpler implementation for the systems using this data as they need to do only a single request to LDAP instead of separate requests to LDAP and the Radius store. In this example it also becomes apparent that the DAP must support a standard LDAP Delete operation. This operation would be performed when a stop accounting request is received and the DAP would remove the mapping from its database.

It will be appreciated that the invention provides very high speed “intelligent” data flows for real time performance of services, some of which involve user interaction in real time. Without the invention some of these services would not be possible. Examples are playing an advertisement a fixed number of times per subscriber, playing “Novice” prompts during the first N logins to the system by a given subscriber, or providing “Help” during the first N notifications reminding a subscriber how to retrieve messages. In addition to providing functionality per subscriber based for example on a fixed number of times that a subscriber has used or has been provided with a particular service, it will be appreciated that the invention allows dynamic attributes to be used handling any data that has transient values to achieve, for example, advanced messaging services such as out-of-office status notifications.

Once the DAP is incorporated into the messaging platform, it can be utilized by any application that needs to manipulate dynamic attributes over a large set of subscribers. The applications that can potentially use this service include, but are not limited to, SMSC, MMSC, VoiceMail, VideoMail, VideoPortal, VoicePortal, and enhanced personalised messaging services platforms, and applications providing personalised routing of messaging traffic.

The invention is not limited to the embodiments described but may be varied in construction and detail.

1-31. (canceled)

32. A messaging system for a communication network, the system comprising:
at least one directory server,
wherein the system further comprises a proxy having a database storing a subset of messaging service attributes and the balance of the attributes being stored in the directory server,
wherein the proxy comprises a server adapted to:
intercept client requests directed to the directory server,
identify, according to a criterion, a subset of attributes associated with the request as dynamic attributes, and to perform high speed write operations on said dynamic attributes in the proxy database to provide enhanced messaging services,
direct requests for the other attributes to the directory server, and to provide a client response.

33. The messaging system as claimed in claim 32, wherein the proxy is adapted to identify attributes as dynamic according to a configuration table.

34. The messaging system as claimed in claim 32, wherein the proxy is adapted to identify as a dynamic attribute an attribute which is a count of a number of times a particular operation has been performed for a subscriber.

35. The messaging system as claimed in claim 32, wherein the proxy is adapted to identify as a dynamic attribute an attribute which is a count of a number of times a particular operation has been performed for a subscriber; and wherein the proxy is adapted to cease maintaining a count of a particular operation when the count value exceeds a threshold.

36. The messaging system as claimed in claim 32, wherein the proxy is adapted to perform a write to the directory server of a dynamic attribute when it lies outside a configured range, so that said attribute ceases to be a dynamic attribute.

37. The messaging system as claimed in claim 32, wherein the proxy is adapted to identify as a dynamic attribute an attribute which is a count of a number of times a particular item of content has been automatically downloaded to a subscriber.

38. The messaging system as claimed in claim 32, wherein the proxy is adapted to identify as a dynamic attribute an attribute which is a count of a number of times a notification has been automatically transmitted to a subscriber.

39. The messaging system as claimed in claim 32, wherein the proxy is also adapted to perform retrieve, modify, or delete operations on said dynamic attributes and to add a new dynamic attribute to the proxy database.

40. The messaging system as claimed in claim 32, wherein the proxy is adapted to generate results using dynamic attributes which it has written to the proxy database and to generate results from requests to the directory server, and to join said results to provide the client response.

41. The messaging system as claimed in claim 32, wherein the proxy database is organised as a hash table with a subscriber identifier as a hash key.

42. The messaging system as claimed in claim 32, wherein, in the proxy database, proxy keys are correlated with directory server keys using a protocol for routing of requests to be handled by the directory server.

43. The messaging system as claimed in claim 42, wherein said protocol is LDAP.

44. The messaging system as claimed in claim 42, wherein a subscriber identifier such as a telephone number is a correlation key.

45. The messaging system as claimed in claim 32, wherein the proxy is multi-threaded in a manner to handle many requests in parallel in a reliable manner.

46. The messaging system as claimed in claim 32, wherein the proxy ensures that transactions are atomic for concurrent access to attributes for a subscriber.

47. The messaging system as claimed in claim 46, wherein the proxy performs atomic transactions composed of reading a record; verifying that a current record value is the same as a current value of a request; changing the current value to that in the request; and writing the record.

48. The messaging system as claimed in claim 46, wherein the proxy uses at least one mutex for operations to ensure atomicity.

49. The messaging system as claimed in claim 32, wherein the proxy is adapted to delete attributes and/or records from its database and to write them to the directory server.

50. The messaging system as claimed in claim 32, wherein the system further comprises at least one server acting as a client, and wherein the proxy is adapted to process requests from one or more servers to provide to the server real time access to the dynamic attributes in a manner which is transparent to the server acting as a client.

51. The messaging system as claimed in claim 32, further comprising a provisioning server acting as a client of the proxy, and wherein the proxy is adapted to:
receive from the provisioning server a request to create records for a new subscriber,
partition the request into dynamic and static attributes, servicing the dynamic attributes itself and passing the remainder of the request to the directory server,
join results from provisioning of both the dynamic attributes and the static attributes to return a provisioning status response to the provisioning server.

52. The messaging system as claimed in claim 32, further comprising a notification server acting as a client, and wherein the proxy is adapted to:
receive from the notification server a query to retrieve notification preferences and settings for a subscriber for whom a message has been deposited in a mailbox;
process dynamic attributes of the query locally, and pass the remainder of the query to the directory server; and
to subsequently join results for the full query and pass them to the notification server.

53. The messaging system as claimed in claim 52, wherein:
the notification server is adapted to use the dynamic attributes within a directory server request to determine if a notification which is to be sent to a subscriber is one of a first number of notifications, and the proxy server is adapted to provide this information by using results from the proxy database, and the proxy server is adapted to subsequently perform a write to a dynamic attribute in response to the notification server requesting modification of this dynamic attribute in order to increment the notification count, and
the notification server is adapted to alter a notification to the subscriber to include a message that reminds the subscriber how to login to their mailbox and send the resultant notification, and to provide an intelligent interface.

54. The messaging system as claimed in claim 32 further comprising a video/voice server and an application server, and wherein the system is adapted to perform the method steps of:
the video/voice server receiving a subscriber call and handing off the call to the application server;
the application server issuing a query to retrieve the settings and preferences for this subscriber;
the proxy processing dynamic attributes of the query locally and passing the remainder of the query to the directory server; and joining the results for all attributes of the query and passing them to the application server.

55. The messaging system as claimed in claim 54, wherein the system is adapted to perform the additional steps of:
the application server determining that the class of service for this subscriber requires that verbose versions of the menus are to be played if the subscriber has logged in less than N times, and noting from result of a query to the proxy that the value of this dynamic attribute is less than N and issuing a modify request to the proxy to increment this value;
the proxy processing the modification of the dynamic attribute, writing the modified value to its database, and returning the result;
the application server counting and classifying messages in the subscriber's mail box;
the application server instructing the voice/video server to play the subscriber's messages and enabling verbose prompting because the login count was less than N, the application server thereby providing an intelligent interface because of the services of the proxy; and
the voice/video server retrieving messages from the store and playing them to the subscriber.

56. The messaging system as claimed in claim 32, wherein the proxy is adapted to use dynamic attributes to control playing of content such as a broadcast alert or advertising content each time a subscriber logs on or receives a notification, and to perform cycling by playing a next item of content if there have been N repetitions of playing current content over a number of messaging sessions for a particular subscriber, a count up to N being a dynamic attribute, and an identifier of current content being another dynamic attribute; and the proxy updating the count dynamic attribute each time content has been played for the subscriber, and updating the current content identifier dynamic attribute upon commencement of each cycle.

57. The messaging system as claimed in claim 32, wherein the subset of attributes identified as dynamic include attributes for handling any data that has transient values, such as Boolean dynamic attributes to indicate whether a subscriber needs a specific service.

58. The messaging system as claimed in claim 57, wherein the subset of attributes includes attributes to record whether an A-party subscriber has already received an out-of-office notification from a given B-party subscriber, wherein a dynamic attribute holds for the out-of-office B-party subscriber the MSISDN of one more A-party to whom an OOTO notification is sent in response to a message delivery attempt from such an A-party to the B-party, and wherein another dynamic attribute indicates whether the B-party subscriber has out-of-office notification service activated.

59. The messaging system as claimed in claim 32, wherein the proxy is adapted to map IP addresses to MSISDNs, whereby instead of storing the IP address to MSISDN mapping in a Radius store, a WAP gateway instead does an LDAP add operation to the proxy when a start accounting request is received.

60. The messaging system as claimed in claim 59, wherein the proxy is adapted to delete a mapping when a stop accounting request is received.

61. The messaging system as claimed in claim 59, wherein the proxy is adapted to combine contents of the Radius store in its database with the subscriber data in LDAP and return this data as a single query result.

62. A computer program product comprising a computer usable medium having a computer readable program code embodied therein, said computer readable code adapted to be executed to implement the steps of:
intercept messaging-related client requests directed to a directory server,
identify, according to a criterion, a subset of attributes associated with the request as dynamic attributes, and perform high speed write operations on said dynamic attributes in a proxy database to provide enhanced messaging services, direct requests for the other attributes to the directory server, and to provide a client response.
